(19) United States
(12) Patent Application Publication
(10) Pub. No.: US 2006/0088804 A1
(43) Pub. Date: Apr. 27, 2006

(54) Learning aid

(76) Inventor: Vernell Wright, Chesapeake, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/970,799

(22) Filed: Oct. 21, 2004

(51) Int. Cl. G09B 19/00; G09B 1/00

(52) U.S. Cl. 434/167

(57) ABSTRACT

A learning aid for teaching characters includes a chair that has a back, seat, legs and support structure securing the back and seat to the legs. The learning aid further includes a set of these chairs. Each chair includes a character such as a letter of an alphabet or a numeral. The character is provided on the back of each chair. In one instance, the character is removable and is fastened to the back of the chair or support structure via fastening means. The fastening means may include complementary strips of magnets or hook and latch material. In another instance, the character is permanently fastened to back of the chair via a fastening device such as a rivet or bolt fastened to the support structure or back of the chair.

There are no related applications.

This patent application did not receive any federal research and development funding.

### BACKGROUND OF THE INVENTION

The present invention is generally related to a learning device for aiding students in learning to read and count. More particularly, the invention is directed to enlarged letters, numerals or characters that are affixed to a chair back for use in educational facilities. By continually exposing children to these oversized letters and numerals during other school activities, the children more readily recognize the letters and numerals.

Phonics is one method of teaching children how to read. Children are taught how to “sound out” new words according to a set of memorized rule. In order to use the phonic method, it is necessary for the children to recognize each letter in a new word.

A second approach to teaching children to read is a “whole language” method. In this approach, teachers use connected print to introduce reading to children. Children are encouraged to memorize words as whole units. This approach also requires children to be able to recognize letters.

Thus, the most important aspect learning to read requires an individual to recognize letters in a word. Likewise, the process of learning basic mathematics requires that children be familiar with numerals. In order for a child to be able to add or subtract, the child must be able to recognize a numeral and its associated value.

There is a positive correlation between a child's reading and arithmetic skills and the amount of exposure that a child receives to letters and numerals during the early years of childhood and schooling. Thus, the more exposure that a child receives to letters and numbers, the better equipped the child will be in later years when reading and practicing mathematics.

### BRIEF SUMMARY OF THE INVENTION

The invention is a stackable chair that includes an oversized letter or numeral, collective referred to hereinafter as a character, affixed to a back of the chair. In one embodiment, the character is affixed to the back of the chair via at least one permanent fastener, preferably a bolt or rivet. In another embodiment, the character is removeably affixed to the back of the chair, via complementary fasteners attached to the character and the back of the chair.

The invention enhances the ability of children to learn the various letters of the alphabet and numerals. Since the chairs are visible during all times that the students are present in the class room, the children are constantly exposed to them. This constant exposure helps the children to read, write, spell and practice basic arithmetic.

The chairs are provided in various sizes. Some of these sizes may include heights of ten, twelve and fourteen inches. Each chair may include a different letter of the alphabet or a different numeral. The characters are approximately one-third the height of the chairs to provide oversized characters that may be easily viewed from across a room. The chairs may comprise various materials such as plastic, chrome and maple and may include contemporary shapes.

The chairs are visible throughout the classroom and are at eyelevel for the children which results in constant exposure of the alphabet and numerals to the children. The invention yields a novel and exciting way of learning.

It is an object of the invention to provide a learning aid for teaching children to learn reading, writing, spelling and/or arithmetic. The learning device constantly provides and eyelevel exposure of characters to students in a classroom.

Additional objects and advantages of the invention will be set forth in part in the description that follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 is a frontal perspective view of a first embodiment of the invention.

FIG. 2 is an elevation view of the first embodiment and taken from the rear.

FIG. 3 is a frontal perspective view of a second embodiment of the invention.

FIG. 4 is an elevation view of the second embodiment of the invention and taken from the rear.

FIG. 5A is an elevation view of the chair and showing a first attachment means. FIG. 5B is an elevation view of a character and showing the attachment means affixed thereto.

FIG. 6A is an elevation view of the chair and a showing a second attachment means. FIG. 6B is an elevation view of a character and showing the second attachment means affixed thereto.

FIG. 7 is a third embodiment of the invention wherein the character is permanently affixed to the back of the chair.

### DETAILED DESCRIPTION OF THE INVENTION

The invention includes a learning aid comprising a chair that includes four legs attached to a support structure that attaches to a chair seat and a chair back having a front side and a back side and a character attached to the back side of the chair back. In one embodiment, an attachment means may include magnetic members, complementary hook and latch material or permanent fastening means. A removable attachment means comprises a first magnetic member having a first polarity and affixed to the character and a second magnetic member having a second polarity and affixed to the back side of the chair back, said first polarity being the opposite of the second polarity. The character may be formed in the shape of a letter or numeral. The character is approximately one-third a height of the chair where the height of the chair is defined between a bottom of the legs that contacts a floor surface and an upper lip of the chair back.

The stackable chair comprises four legs and a chair back having a front side and a back side and attached to the four legs via a support structure and fastening means. A seat attaches to the four legs via fastening means. A character affixes to the back side of the chair back. The stackable chair may include an attachment means selected from a group consisting of magnetic members, complementary hook and latch material and permanent fastening means. The stackable chair may include a removable attachment means comprising a first magnetic member having a first polarity and affixed to the character and a second magnetic member having a second polarity and affixed to the back side of the chair back, wherein the first polarity being the opposite of the second polarity. The character is formed in the shape of a letter or numeral.

A learning aid comprises a chair that includes a back, a seat and legs, said legs being attached to the back and seat via a support structure. The learning aid further includes a character formed in the shape of one of a letter or numeral and attached to the back. A removable attachment means may include a first magnetic member having a first polarity and affixed to the character and a second magnetic member having a second polarity and affixed to the back of the chair back, said first polarity being the opposite of the second polarity. A removable attachment means for attaching the character may include a first strip of complementary hook and latch material attached to the back of the chair and a second strip of complementary hook and latch material attached to the character.

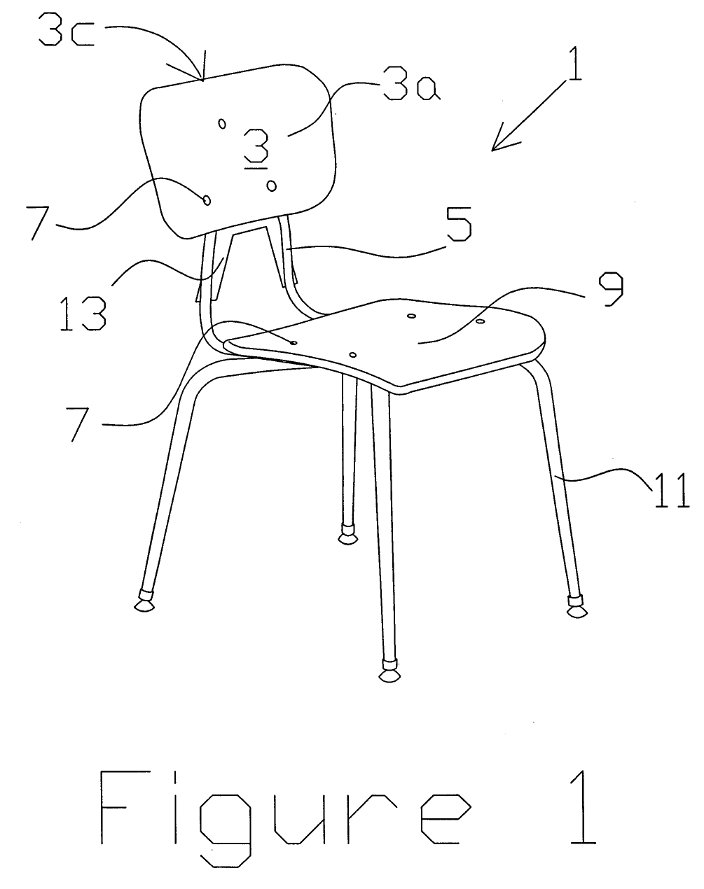

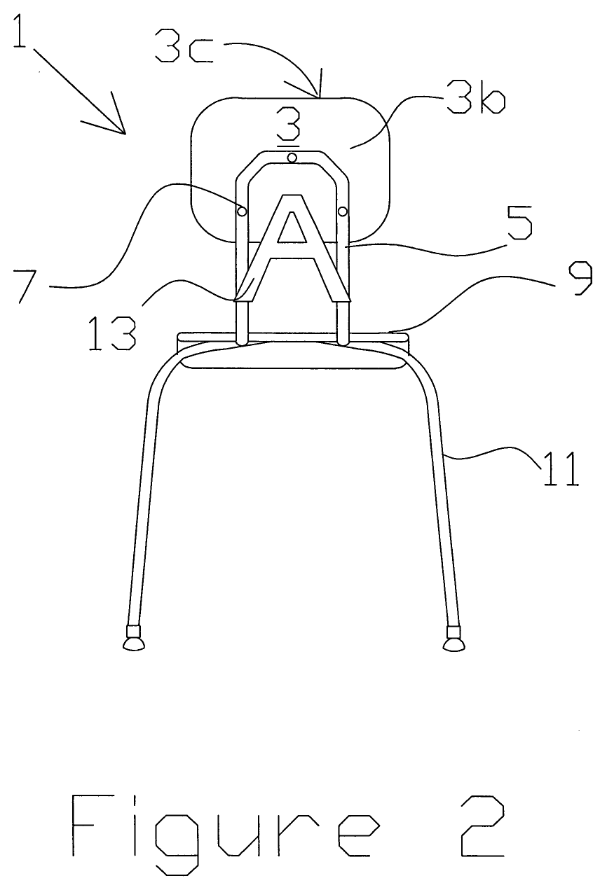

Now referring to FIGS. 1 and 2, which depict a first embodiment of the invention. The learning aid 1 comprises a chair that includes a chair back 3. The chair back 3 includes a front surface 3A, a back surface 3B and an upper lip 3C. The front surface 3A contacts the back of the student when the student is seated in the chair. Support structure 5 connects seat 9 to back 3. A series of fastening devices 7 affixes the back 3 to support structure 5. The fastening devices may comprise a known bolt-nut combination or a rivet. Legs 11 attach to seat 9 via fastening means 7. A character 13 formed in the shape of a letter affixes to the back side 3B of chair back 3 as shown in FIG. 2.

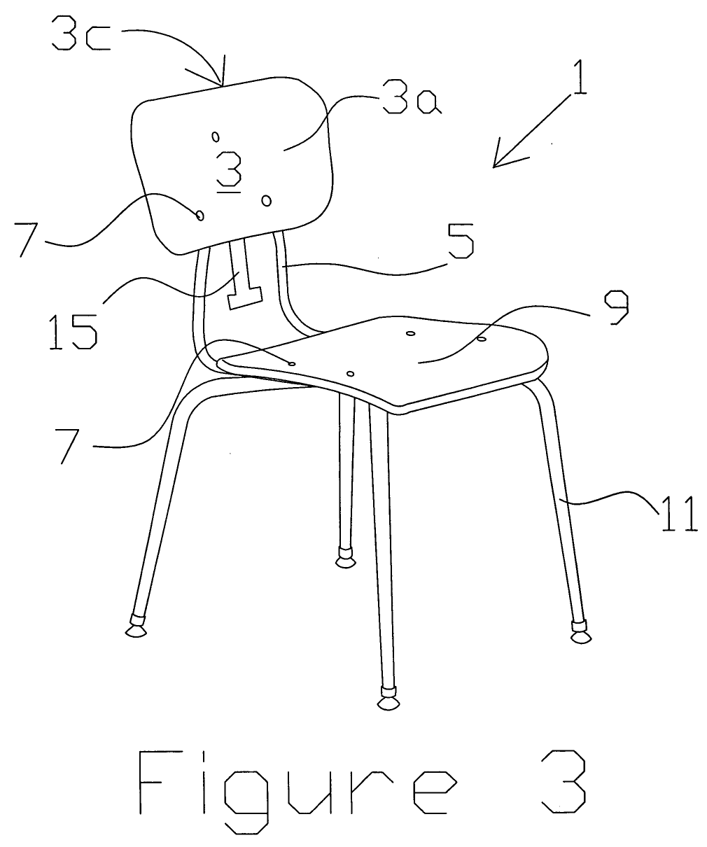

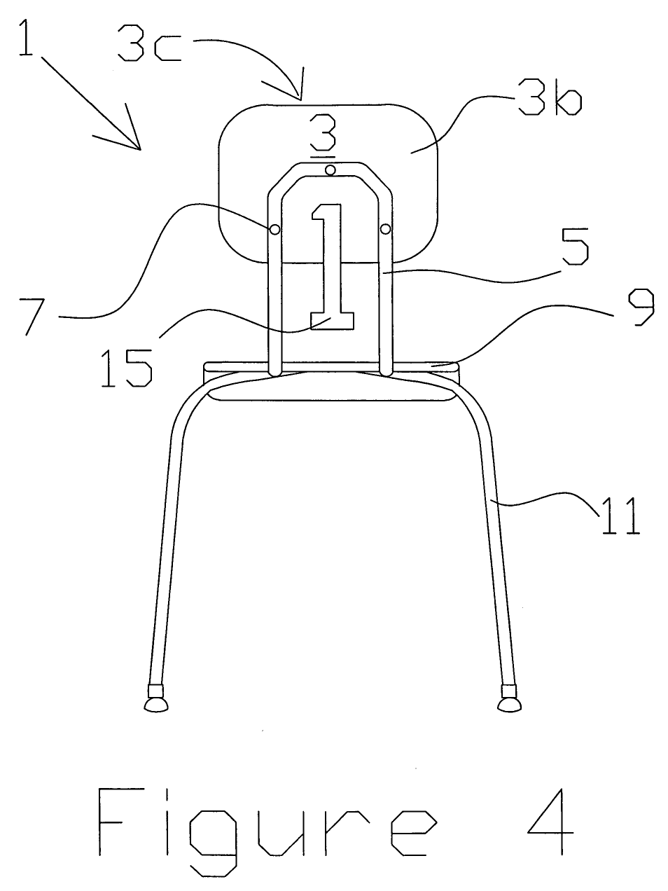

A second embodiment of the invention is shown in FIGS. 3 and 4. In this embodiment, the character 15 is formed in the shape of a numeral. In the preferred embodiment, the characters 13 and 15 are approximately one-third the height of the distance between the upper surface 3C of chair back 3 and the floor or surface upon which the chair rests. This size assures that the students are constantly exposed to the characters even from a distance.

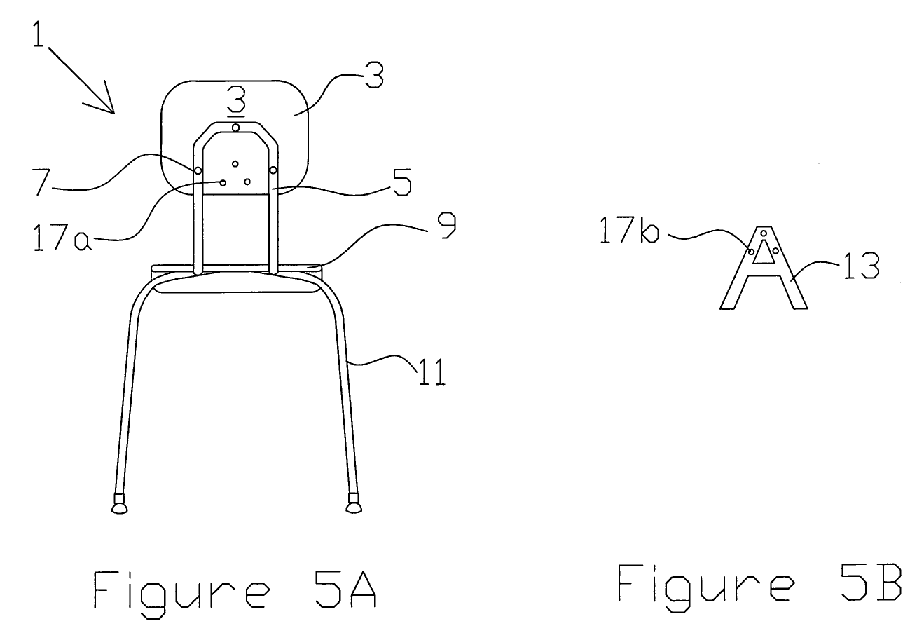

FIGS. 5A and 5B show a first method and means for attaching the character 13 or 15 to the backside 3B of the chair back 3. A pair of magnets may be used to secure the character to the chair. In this instance, a removable attachment means comprises include a set of first magnetic members 17A having a first polarity and affixed to the backside 3B of the chair back 3 via an adhesive or the like. A set of second magnetic members 17B, having a second polarity, are affixed to the character 13 in a likewise fashion. The first polarity has a magnetic charge opposite that of the second polarity. There exists a magnetic attraction between the first and second sets of magnets. The magnets may be strategically placed on the surface of the backside of the chair back to accommodate different shaped characters. Thus, the characters may be easily removed and rearranged on various chairs without the need for moving the chairs.

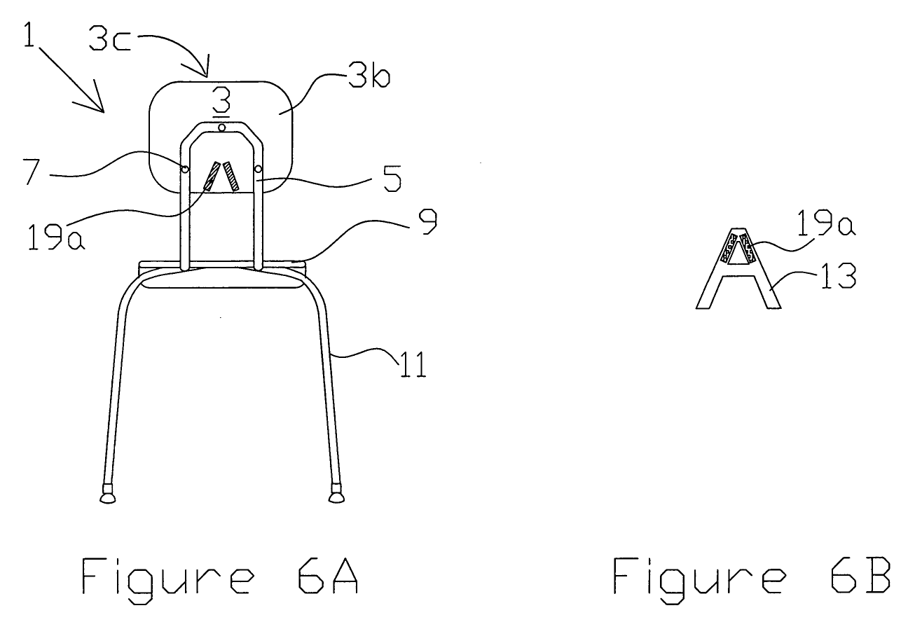

FIGS. 6A and 6B show a second method and means for attaching the characters 13 or 15 to the backside 3B of the chair back 3. In this instance, the removable attachment means includes complementary strips of hook and latch material for affixing the characters to the backside of the chair back. A first set of strips of complementary hook and latch material 19A attaches to the backside 3B of the chair; while a second strip of complementary hook and latch material 19B attaches to the character 13. Typically, a glue or adhesive affixes the hook and latch material 19 to their respective parts of the learning aid.

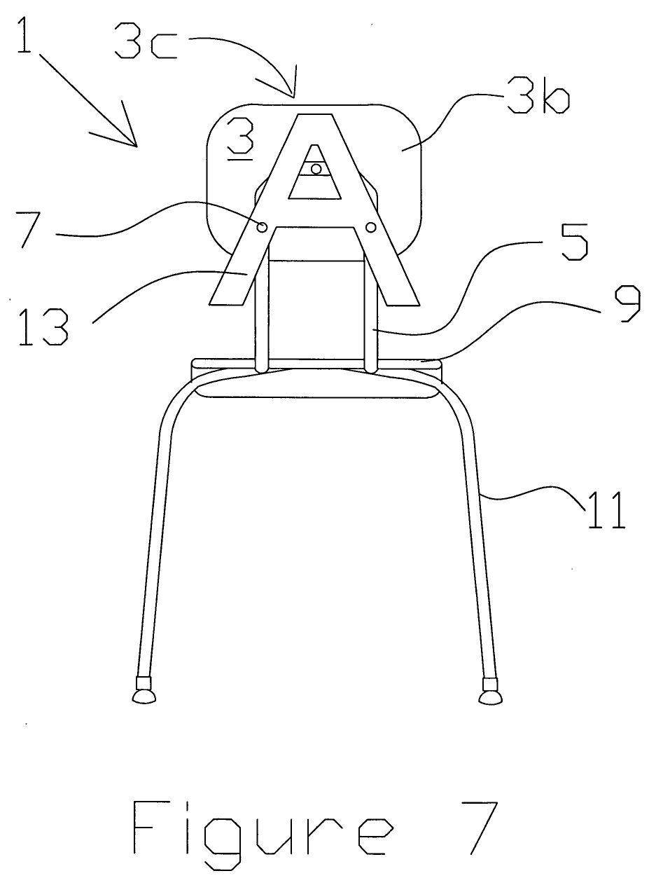

FIG. 7 depicts a third method and means for attaching the character to the backside of the chair back. In this instance, the character is permanently affixed to the chair back via the fastening means 7 that attach the chair back 3 to the support members 5.

It is to be understood that the invention is not limited to the exact construction illustrated and described above, but that various changes and modifications may be made without departing from the spirit and the scope of the invention as defined in the following claims.

1. A learning aid comprising a stackable chair that includes four legs attached to a support structure that attaches to a chair seat and a chair back having a front side and a back side and a character attached to the back side of the chair back.

2. The learning aid of claim 1 further comprising an attachment means selected from a group consisting of magnetic members, complementary hook and latch material and permanent fastening means, said attachment means attaches the character to the chair back.

3. The learning aid of claim 1 further comprising a removable attachment means comprising a first magnetic member having a first polarity and affixed to the character and a second magnetic member having a second polarity and affixed to the back side of the chair back, said first polarity being the opposite of the second polarity.

4. The learning aid of claim 1 wherein said character is formed in the shape of a letter.

5. The learning aid of claim 1 wherein said character is formed in the shape of a numeral.

6. The learning aid of claim 1 wherein said character is approximately one-third a height of the chair, said height of the chair being defined between a bottom of the legs that contacts a floor surface and an upper lip of the chair back.

7. A stackable chair comprising:
four legs;
a chair back having a front side and a back side and attached to said four legs via a support structure and fastening means;
a seat attached to the four legs via fastening means; and,
a character affixed to the back side of the chair back.

8. The stackable chair of claim 7 further including an attachment means selected from a group consisting of magnetic members, complementary hook and latch material and permanent fastening means.

9. The stackable chair of claim 7 further comprising a removable attachment means comprising a first magnetic member having a first polarity and affixed to the character and a second magnetic member having a second polarity and affixed to the back side of the chair back, said first polarity being the opposite of the second polarity.

10. The stackable chair of claim 7 wherein said character is formed in the shape of a letter.

11. The stackable chair of claim 7 wherein said character is formed in the shape of a numeral.

12. A learning aid comprising a stackable chair that includes a back, a seat and legs, said legs being attached to the back and seat via a support structure, said learning aid further including a character formed in the shape of one of a letter or numeral and attached to a back surface side of said back.

13. The learning aid of claim 12 further comprising a removable attachment means including a first magnetic member having a first polarity and affixed to the character and a second magnetic member having a second polarity and affixed to the back of the chair back, said first polarity being the opposite of the second polarity.

14. The learning aid of claim 12 further comprising a removable attachment means including a first strip of complementary hook and latch material attached to the back of the chair and a second strip of complementary hook and latch material attached to the character.
